(19) United States
(12) Patent Application Publication
(10) Pub. No.: US 2025/0338208 A1
(43) Pub. Date: Oct. 30, 2025

(54) ALTERNATIVE QUALITY OF SERVICE FOR ENERGY EFFICIENCY MODE OPERATIONS

(71) Applicant: QUALCOMM Incorporated, San Diego, CA (US)

(72) Inventors: Miguel GRIOT, La Jolla, CA (US); Olufunmilola Omolade AWONIYI-OTERI, San Diego, CA (US)

(21) Appl. No.: 18/648,006

(22) Filed: Apr. 26, 2024

(51) Int. Cl. H04W 52/02; H04W 28/02; H04W 76/10

(52) U.S. Cl. CPC H04W 52/0203; H04W 28/0268; H04W 76/10

(57) ABSTRACT

Methods, systems, and devices for wireless communications are described. A wireless communication device may modify Quality of Service (QOS) flows of multiple QoS flows associated with a protocol data unit (PDU) session in accordance with alternative QoS profiles based on an energy efficiency mode. For example, a first network entity may establish a PDU session with a user equipment (UE) via a session establishment procedure. The first network entity may determine to enter the energy efficiency mode based on network parameters, where the energy efficiency mode is associated with the alternative QoS profiles that are different from a set of QoS profiles of the PDU session. The first network entity may output a message indicating that the first network entity is entering the energy efficiency mode and that the PDU session is modified in accordance with the alternative QoS profiles based at least in part on the energy efficiency mode.

### FIELD OF TECHNOLOGY

The following relates to wireless communications, including alternative Quality of Service (QOS) for energy efficiency mode operations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). In some cases, wireless communication systems may support energy efficiency modes in which one or more communications parameters are adjusted to improve energy efficiency at one or more devices.

### SUMMARY

The systems, methods, and devices of this disclosure each have several innovative aspects, no single one of which is solely responsible for the desirable attributes disclosed herein.

A method for wireless communications by a first network entity is described. The method may include establishing a packet data unit (PDU) session with a user equipment (UE) via a session establishment procedure, determining to enter an energy efficiency mode based on one or more network parameters, where the energy efficiency mode is associated with one or more alternative quality of service (QOS) profiles that are different from a set of QoS profiles of the PDU session, and where the one or more alternative QoS profiles are allowed for the PDU session based on an agreement associated with the UE, and outputting a message indicating that the first network entity is entering the energy efficiency mode and that the PDU session is modified in accordance with the one or more alternative QoS profiles based on the energy efficiency mode.

A first network entity for wireless communications is described. The first network entity may include one or more memories storing processor executable code, and one or more processors coupled with the one or more memories. The one or more processors may individually or collectively be operable to execute the code to cause the first network entity to establish a PDU session with a UE via a session establishment procedure, determine to enter an energy efficiency mode based on one or more network parameters, where the energy efficiency mode is associated with one or more alternative QOS profiles that are different from a set of QoS profiles of the PDU session, and where the one or more alternative QoS profiles are allowed for the PDU session based on an agreement associated with the UE, and output a message indicating that the first network entity is entering the energy efficiency mode and that the PDU session is modified in accordance with the one or more alternative QoS profiles based on the energy efficiency mode.

Another first network entity for wireless communications is described. The first network entity may include means for establishing a PDU session with a UE via a session establishment procedure, means for determining to enter an energy efficiency mode based on one or more network parameters, where the energy efficiency mode is associated with one or more alternative QoS profiles that are different from a set of QoS profiles of the PDU session, and where the one or more alternative QoS profiles are allowed for the PDU session based on an agreement associated with the UE, and means for outputting a message indicating that the first network entity is entering the energy efficiency mode and that the PDU session is modified in accordance with the one or more alternative QoS profiles based on the energy efficiency mode.

A non-transitory computer-readable medium storing code for wireless communications is described. The code may include instructions executable by one or more processors to establish a PDU session with a UE via a session establishment procedure, determine to enter an energy efficiency mode based on one or more network parameters, where the energy efficiency mode is associated with one or more alternative QoS profiles that are different from a set of QoS profiles of the PDU session, and where the one or more alternative QoS profiles are allowed for the PDU session based on an agreement associated with the UE, and output a message indicating that the first network entity is entering the energy efficiency mode and that the PDU session is modified in accordance with the one or more alternative QoS profiles based on the energy efficiency mode.

Some examples of the method, first network entities, and non-transitory computer-readable medium described herein may further include operations, features, means, or instructions for determining to exit the energy efficiency mode based on the one or more network parameters and outputting a second message indicating that the first network entity may be exiting the energy efficiency mode and that the PDU session may be modified in accordance with the set of QoS profiles of the PDU session based on exiting the energy efficiency mode.

Some examples of the method, first network entities, and non-transitory computer-readable medium described herein may further include operations, features, means, or instructions for obtaining a second message indicating the one or more alternative QoS profiles associated with the energy efficiency mode, where determining to enter the energy efficiency mode may be based on receiving the second message.

Some examples of the method, first network entities, and non-transitory computer-readable medium described herein may further include operations, features, means, or instructions for obtaining a second message indicating one or more QoS flows associated with the one or more alternative QoS profiles, where the PDU session may be associated with the one or more QoS flows.

In some examples of the method, first network entities, and non-transitory computer-readable medium described herein, outputting the message may include operations, features, means, or instructions for outputting, to the UE, the message indicating that the first network entity may be entering the energy efficiency mode.

In some examples of the method, first network entities, and non-transitory computer-readable medium described herein, outputting the message may include operations, features, means, or instructions for outputting, to a second network entity via a third network entity, the message indicating that the first network entity may be entering the energy efficiency mode.

In some examples of the method, first network entities, and non-transitory computer-readable medium described herein, the message indicates one or more QoS flows that may be associated with the one or more alternative QoS profiles.

In some examples of the method, first network entities, and non-transitory computer-readable medium described herein, the first network entity includes a radio access network (RAN) node, the second network entity includes a session management function (SMF), and the third network entity includes an access and mobility management function (AMF).

In some examples of the method, first network entities, and non-transitory computer-readable medium described herein, the message further indicates a PDU session identifier, session management information, the one or more alternative QoS profiles, or any combination thereof and the session management information includes one or more QoS flow identifiers (QFIs) associated with the one or more alternative QoS profiles.

In some examples of the method, first network entities, and non-transitory computer-readable medium described herein, the one or more network parameters include a traffic load associated with one or more cells, a quantity of one or more UEs associated with the first network entity, a location of the one or more UEs, a communication mode of the one or more UEs, or any combination thereof.

In some examples of the method, first network entities, and non-transitory computer-readable medium described herein, the one or more alternative QoS profiles may be associated with one or more first parameters, the one or more first parameters may be different than one or more second parameters associated with the set of QoS profiles, and the one or more first parameters and the one or more second parameters include a guaranteed bit rate (GBR), a maximum bit rate (MBR), a packet delay budget, a packet error rate, or any combination thereof.

A method for wireless communications by a first network entity is described. The method may include obtaining a message indicating that a second network entity is entering an energy efficiency mode and further indicating that one or more QoS flows of a set of multiple QoS flows are modified in accordance with one or more alternative QoS profiles based on the energy efficiency mode, the one or more QoS flows associated with a PDU session between the first network entity and a UE, where the one or more alternative QoS profiles are different from a set of QoS profiles of the PDU session, modifying the PDU session in accordance with the one or more alternative QoS profiles, and outputting a response message including an indication of an updated PDU session in accordance with the modified PDU session and the one or more alternative QoS profiles.

A first network entity for wireless communications is described. The first network entity may include one or more memories storing processor executable code, and one or more processors coupled with the one or more memories. The one or more processors may individually or collectively be operable to execute the code to cause the first network entity to obtain a message indicating that a second network entity is entering an energy efficiency mode and further indicating that one or more QoS flows of a set of multiple QoS flows are modified in accordance with one or more alternative QoS profiles based on the energy efficiency mode, the one or more QoS flows associated with a PDU session between the first network entity and a UE, where the one or more alternative QoS profiles are different from a set of QoS profiles of the PDU session, modify the PDU session in accordance with the one or more alternative QoS profiles, and output a response message including an indication of an updated PDU session in accordance with the modified PDU session and the one or more alternative QoS profiles.

Another first network entity for wireless communications is described. The first network entity may include means for obtaining a message indicating that a second network entity is entering an energy efficiency mode and further indicating that one or more QoS flows of a set of multiple QoS flows are modified in accordance with one or more alternative QoS profiles based on the energy efficiency mode, the one or more QoS flows associated with a PDU session between the first network entity and a UE, where the one or more alternative QoS profiles are different from a set of QoS profiles of the PDU session, means for modifying the PDU session in accordance with the one or more alternative QoS profiles, and means for outputting a response message including an indication of an updated PDU session in accordance with the modified PDU session and the one or more alternative QoS profiles.

A non-transitory computer-readable medium storing code for wireless communications is described. The code may include instructions executable by one or more processors to obtain a message indicating that a second network entity is entering an energy efficiency mode and further indicating that one or more QoS flows of a set of multiple QoS flows are modified in accordance with one or more alternative Qos profiles based on the energy efficiency mode, the one or more QoS flows associated with a PDU session between the first network entity and a UE, where the one or more alternative QoS profiles are different from a set of QOS profiles of the PDU session, modify the PDU session in accordance with the one or more alternative QoS profiles, and output a response message including an indication of an updated PDU session in accordance with the modified PDU session and the one or more alternative QoS profiles.

Some examples of the method, first network entities, and non-transitory computer-readable medium described herein may further include operations, features, means, or instructions for outputting a second message indicating that the second network entity may be entering the energy efficiency mode in accordance with one or more policy and charging control (PCC) rules, the one or more PCC rules associated with the energy efficiency mode.

In some examples of the method, first network entities, and non-transitory computer-readable medium described herein, modifying the PDU session may include operations, features, means, or instructions for outputting a second message indicating that the second network entity may be entering the energy efficiency mode and identifying one or more QoS flows associated with the one or more alternative QoS profiles in accordance with the energy efficiency mode.

In some examples of the method, first network entities, and non-transitory computer-readable medium described herein, outputting the second message may include operations, features, means, or instructions for outputting the second message identifying the one or more QoS flows associated with the one or more alternative QoS profiles, where a usage charging data record (CDR) associated with the UE may be updated in accordance with a charging rate associated with the one or more alternative QoS profiles.

Some examples of the method, first network entities, and non-transitory computer-readable medium described herein may further include operations, features, means, or instructions for obtaining a second message indicating that the second network entity may be exiting the energy efficiency mode and that the PDU session may be modified in accordance with the set of QoS profiles of the PDU session based on exiting the energy efficiency mode.

In some examples of the method, first network entities, and non-transitory computer-readable medium described herein, obtaining the message may include operations, features, means, or instructions for obtaining, from the second network entity via a third network entity, the message indicating that the second network entity may be entering the energy efficiency mode.

In some examples of the method, first network entities, and non-transitory computer-readable medium described herein, the first network entity includes an AMF, the second network entity includes a RAN node, and the third network entity includes a SMF.

In some examples of the method, first network entities, and non-transitory computer-readable medium described herein, the message further indicates a PDU session identifier, session management information, the one or more alternative QoS profiles, or any combination thereof and the session management information includes one or more QFIs associated with the one or more alternative QoS profiles.

In some examples of the method, first network entities, and non-transitory computer-readable medium described herein, the one or more alternative QoS profiles may be associated with one or more first parameters, the one or more first parameters may be different than one or more second parameters associated with the set of QoS profiles, and the one or more first parameters and the one or more second parameters include a GBR, a MBR, a packet delay budget, a packet error rate, or any combination thereof.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows an example of a wireless communications system that supports alternative Quality of Service (QOS) for energy efficiency mode operations in accordance with one or more aspects of the present disclosure.

FIG. 2 shows an example of a network architecture that supports alternative QoS for energy efficiency mode operations in accordance with one or more aspects of the present disclosure.

FIG. 3 shows an example of a wireless communication system that supports alternative QoS for energy efficiency mode operations in accordance with one or more aspects of the present disclosure.

FIG. 4 shows an example of a process flow that supports alternative QoS for energy efficiency mode operations in accordance with one or more aspects of the present disclosure.

FIGS. 5 and 6 show block diagrams of devices that support alternative QoS for energy efficiency mode operations in accordance with one or more aspects of the present disclosure.

FIG. 7 shows a block diagram of a communications manager that supports alternative QoS for energy efficiency mode operations in accordance with one or more aspects of the present disclosure.

FIG. 8 shows a diagram of a system including a device that supports alternative QoS for energy efficiency mode operations in accordance with one or more aspects of the present disclosure.

FIGS. 9 and 10 show block diagrams of devices that support alternative QoS for energy efficiency mode operations in accordance with one or more aspects of the present disclosure.

FIG. 11 shows a block diagram of a communications manager that supports alternative QoS for energy efficiency mode operations in accordance with one or more aspects of the present disclosure.

FIG. 12 shows a diagram of a system including a device that supports alternative QoS for energy efficiency mode operations in accordance with one or more aspects of the present disclosure.

FIGS. 13 through 16 show flowcharts illustrating methods that support alternative QoS for energy efficiency mode operations in accordance with one or more aspects of the present disclosure.

### DETAILED DESCRIPTION

In some wireless communications systems, wireless communications devices may operate in an energy efficiency mode. In some cases, the energy efficiency mode may also be referred to as a green mode, a power saving mode, or the like. In accordance with the energy efficiency mode, a network entity may enter into a sleep state in which one or more signals are not transmitted, received, or both; reduce communications in one or more cells, refrain from communicating in one or more cells, or both; refrain from performing some processing types, such as processing types associated with relatively high levels of energy use compared to other processing types (e.g., fast processing); or any combination thereof, among other examples. The energy efficiency mode, while improving network-side energy saving, may be associated with relatively reduced performance at the network entity. For example, the energy efficiency mode may be associated with a decreased probability of satisfying one or more quality of service (QOS) parameters for one or more QoS flows of a PDU session between the network entity and another wireless communication device, such as a user equipment (UE). As such, energy efficiency modes may be associated with the management of PDU sessions for one or more wireless communications devices.

As described herein, a wireless communication system may support techniques for utilization of alternative QoS profiles in examples in which a network entity enters the energy efficiency mode and is unable to meet the one or more Qos parameters for the one or more QoS flows of the PDU session based on the reduced performance associated with the energy efficiency mode. The energy efficiency mode may be associated with alternative QoS profiles for one or more QoS flows of the PDU session, such as alternative QoS profiles associated with different parameters compared to QoS profiles used prior to entering or after exiting the energy efficiency mode (e.g., QoS parameters associated with a regular operation). For example, a radio access network (RAN) node may enter the energy efficiency mode based on a UE (e.g., or one or more UEs connected to the RAN node) agreeing to a policy associated with the energy efficiency mode, where the policy indicates that the energy efficiency mode is associated with the alternative QoS profiles. In some examples, the RAN node may determine to enter the energy efficiency mode based on network parameters, such as whether one or more QoS flows of an established PDU session with the UE would be affected by the energy efficiency mode. Additionally, or alternatively, the RAN node may determine to enter the energy efficiency mode based on whether one or more flows identified as being potentially affected by the energy efficiency mode are associated with the alternative QoS profiles under the energy efficiency mode.

The RAN node may indicate that the energy efficiency mode is to be used to one or more other network entities, including a session management function (SMF). The SMF may update the PDU session in accordance with the alternative QoS profiles and indicate the energy efficiency mode of the RAN node to additional entities, including to a user plane function (UPF), which may record the usage charging data records (CDR) associated with the alternative QoS operation, and to a policy control function (PCF), which may indicate which QoS flows of the PDU session are associated with the alternative QoS profile according to a policy associated with the UE. In some examples, use of the energy efficiency mode may be incentivized via a reduced cost to the user. For example, a network entity, such as the UPF, may record an amount of data transported while the energy efficiency mode is in use, such that a user of the UE may be charged a different rate (e.g., a relatively reduced rate) for the amount of data and accordingly be incentivized to enable the alternative QoS operation for the UE (e.g., despite the reduced performance associated with the energy efficiency mode).

Aspects of the disclosure are initially described in the context of wireless communications systems. Aspects of the disclosure are also described in the context of a process flow. Aspects of the disclosure are further illustrated by and described with reference to apparatus diagrams, system diagrams, and flowcharts that relate to alternative QoS for energy efficiency mode operations.

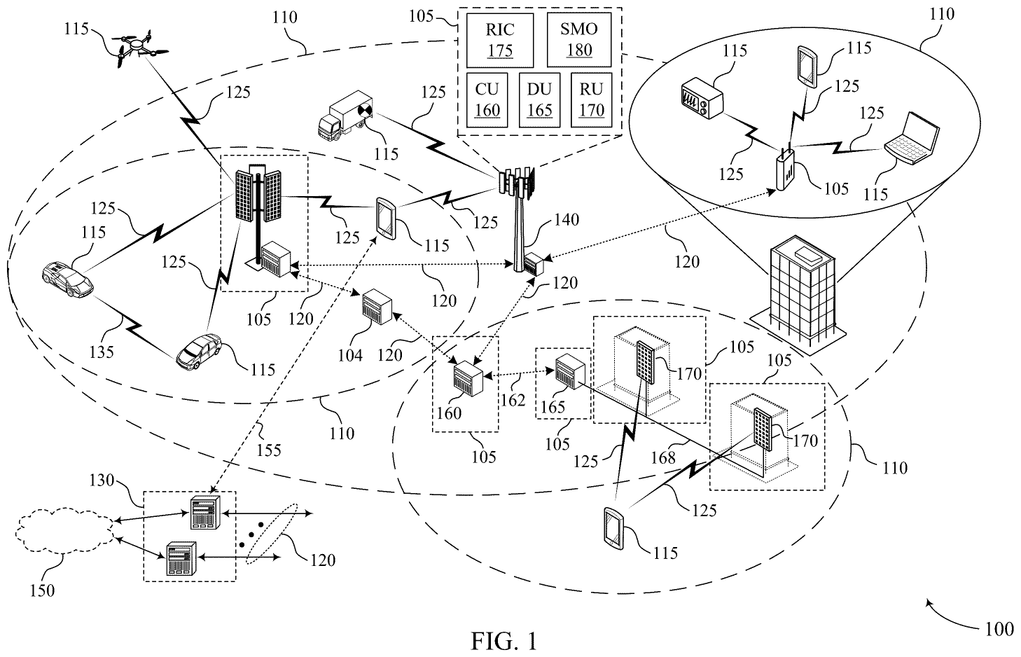

FIG. 1 shows an example of a wireless communications system 100 that supports alternative QoS for energy efficiency mode operations in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a RAN node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (CNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a UPF). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

As described herein, a wireless communication device, such as the network entity 105 (e.g., a RAN node), may modify one or more QoS flows of multiple QoS flows associated with a PDU session in accordance with alternative QoS profiles based on an energy efficiency mode. For example, the network entity 105 may establish a PDU session with a UE 115 via a session establishment procedure. The network entity 105 may determine to enter the energy efficiency mode based on network parameters, where the energy efficiency mode is associated with the alternative QoS profiles that are different from a set of QoS profiles of the PDU session. For example, the network entity 105 may determine whether a UE 115 associated with one or more PDU sessions is associated with an agreement to enable one or more alternative QoS profiles for the one or more PDU sessions for the energy efficiency mode. In such cases, a presence of the agreement may enable the network entity 105 to enter the energy efficiency mode and utilize the alternative QoS profiles for the UE 115, whereas an absence of the agreement may, in some cases, prevent the network entity 105 from entering into the energy efficiency mode (or otherwise affect one or more parameters associated with the energy efficiency mode such that one or more QoS profiles associated with the UE 115 may not be affected). In some aspects (e.g., when transitioning to the energy efficiency mode), the network entity 105 may output a message indicating that the network entity 105 is entering the energy efficiency mode and that the PDU session is modified in accordance with the alternative QoS profiles based on the energy efficiency mode. Other network entities, such as entities of the core network 130, may modify the PDU session based on obtaining the message indicating that the network entity 105 is entering the energy efficiency mode. For example, an SMF of the core network 130 may modify the QoS flows of the multiple QoS flows associated with the PDU session in accordance with the alternative QoS profiles.

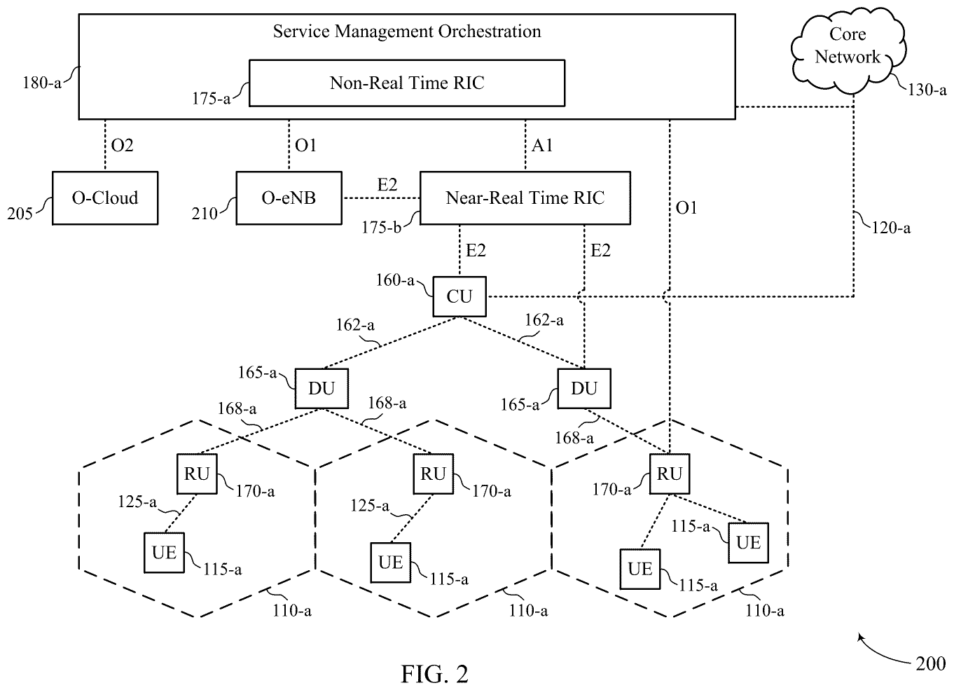

FIG. 2 shows an example of a network architecture 200 (e.g., a disaggregated base station architecture, a disaggregated RAN architecture) that supports alternative QoS for energy efficiency mode operations in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-cNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

The network architecture 200 may support techniques for modifying one or more QoS flows of multiple QoS flows associated with a PDU session in accordance with alternative QoS profiles based on an energy efficiency mode. For example, the network entity may establish one or more PDU sessions with a UE 115-a via a session establishment procedure. The network entity may determine to enter the energy efficiency mode based on one or more network parameters, where the energy efficiency mode is associated with the alternative QoS profiles that are different from a set of QoS profiles (e.g., originally configured QoS profiles) of the PDU session. In some aspects, the network entity may output a message indicating that the network entity is entering the energy efficiency mode and that the PDU session is modified in accordance with the alternative QoS profiles based on the energy efficiency mode. Other network entities, such as entities of a core network, may modify the PDU session based on obtaining the message indicating that the network entity is entering the energy efficiency mode. For example, an SMF of the core network may modify the QoS flows of the multiple QoS flows associated with the PDU session in accordance with the alternative QoS profiles.

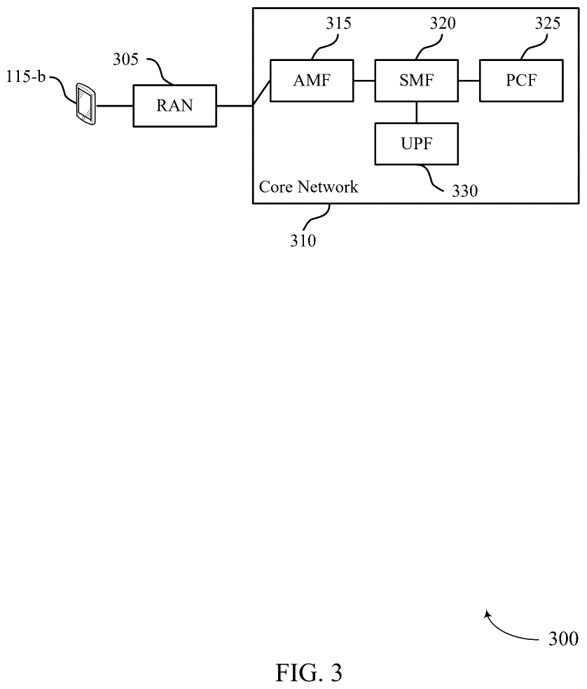

FIG. 3 shows an example of a wireless communications system 300 that supports alternative QoS for energy efficiency mode operations in accordance with one or more aspects of the present disclosure. The wireless communications system 300 may implement or be implemented by various aspects of the wireless communications system 100. For example, the wireless communications system 300 may include a UE 115-b, which may be an example of the UE 115 as described with reference to FIG. 1 and FIG. 2. Additionally, the wireless communications system 300 may include a RAN 305 and a core network 310, which may be examples of the network entity 105 and the core network 130, respectively, as described with reference to FIG. 1. For example, the core network 310 may be an EPC or 5GC including a control plane entity that manages access and mobility, such as an AMF 315. Additionally, the core network 310 may include a user plane entity that routes packets or interconnects to external networks, such as a UPF 330, and one or more other entities including an SMF 320 and a PCF 325.

In some examples, the RAN 305 may support an energy efficiency mode. The energy efficiency mode may affect a performance associated with one or more services for the UE 115-b, such as one or more parameter associated with QoS. For example, during the energy efficiency mode, the RAN 305 may perform one or more energy-saving operations, including entering a sleep state (e.g., perform microsleeps) in which blank frames may be exchanged between the UE 115-b and the RAN 305, spreading communication across frames, reducing communications on (e.g., turn down) one or more cells, refraining from communicating on (e.g., turn off) one or more cells, refraining from performing one or more processing operations (e.g., fast processing), or the like. The energy-saving operations may be associated with reduced performance, such as a reduced processing capability, latency, or the like. The RAN 305 may not satisfy thresholds associated with one or more QoS flows based on the reduced performance.

The UE 115-b and the RAN 305 may establish a PDU session in accordance with a set of QoS profiles, where the PDU session includes multiple QoS flows. In some examples, each of the QoS flows may be associated with one or more thresholds, such as guaranteed bit rates (GBRs). In the example of one or more QoS flows of the PDU session being associated with GBRs, the RAN 305 may be unable to satisfy a GBR based on a reduced bit rate associated with the energy efficiency mode. In some cases, the inability of the RAN 305 to satisfy the GBR may result in limited use of the energy efficiency mode, which may degrade energy performance of the RAN 305. In order to support use of the energy efficiency mode by the RAN 305, the energy efficiency mode may be associated with one or more alternative QoS profiles different than the set of QOS profiles of the PDU session.

The alternative QoS profiles may be associated with different parameters than the set of QoS profiles used prior to entering (e.g., or after exiting) the energy efficiency mode. For example, the alternative QoS profiles may be associated with different GBRs, maximum bit rates (MBRs), packet delay budgets, packet error rates, or the like, than the set of QoS profiles. The parameters of the alternative QoS profiles may be less than parameters of the set of QoS profiles. As an example, the alternative QoS profiles may be associated with a first GBR, which may be lower than a second GBR associated with the set of QoS profiles.

After establishing the PDU session with the UE 115-b, the RAN 305 may determine to enter the energy efficiency mode. For example, to determine whether to enter the energy efficiency mode (e.g., or after receiving a user plane activation request from the SMF 320), the RAN 305 may determine whether QoS parameters associated with a regular operation may be satisfied for each of the multiple QoS flows of the PDU session based on network parameters (e.g., a traffic load associated with cells, a quantity of one or more UEs 115 associated with the RAN 305, a location of the one or more UEs 115, a communication mode of the one or more UEs, among other examples). The RAN 305 may determine whether the alternative QoS parameters may be satisfied for each of the multiple QoS flows of the PDU session after determining that the QoS parameters for the regular operation are not satisfied. Alternatively, the RAN 305 may continue the PDU session (e.g., accept QoS flow(s)) using the QoS parameters associated with the regular operation based on determining that the QoS parameters for the regular operation are satisfied.

Based on determining that the RAN 305 may satisfy the alternative QoS parameters, the RAN 305 may output an indication to the SMF 320 (e.g., via the AMF 315) that the RAN 305 is entering the energy efficiency mode and using the alternative QoS profiles. Additionally, or alternatively, the RAN 305 may output the indication to the UE 115-b that RAN 305 is entering the energy efficiency mode and that the alternative QoS profiles are used for the PDU session. In some examples, the RAN 305 may determine to exit the energy efficiency mode (e.g., based on the QoS parameters associated with the regular operation being satisfied according to the network conditions) and output indications to the SMF 320, the UE 115-b, or both, indicating that the RAN 305 is exiting the energy efficiency mode and the set of QoS profiles associated with the regular operation are used.

The core network 310 may perform one or more operations in accordance with the energy efficiency mode at the RAN 305. For example, the SMF 320 may provide the UE 115-b, the RAN 305, or both with the set of QoS profiles associated with the regular operation and the alternative QoS profiles associated with the energy efficiency mode operation. The SMF 320 may obtain the indication from the RAN 305 (e.g., via the AMF 315) that the alternative QoS profile associated with the energy efficiency mode is used for the UE 115-b (e.g., a PDU session with the UE 115-b). In response to obtaining the indication from the RAN 305, the SMF 320 may forward information associated with the energy efficiency mode to the UPF 330. Additionally, or alternatively, the SMF 320 may output the information to an application function (AF). For example, the SMF 320 may output the information to the AF directly (e.g., based on a level of trust) or via a network exposure function (NEF). In some examples, the SMF 320 may indicate use of the alternative QoS policies based on the energy efficiency mode to the PCF 325, to the UE 115-b (e.g., via session management signaling in PDU session modification), or both. In some examples, such as examples in which the RAN 305 determines to exit the energy efficiency mode, the SMF 320 may indicate use of the set of QoS profiles associated with the regular operation and indicate that the RAN 305 is exiting the energy efficiency mode to the UPF 330, the AF, the PCF 325, the UE 115-b, or any combination thereof.

In some examples, a home public land mobile network (HPLMN) may incentivize a user of the UE 115-b to enable the energy efficiency mode based on a promotion, such as a payment credit, a lower data rate (e.g., cost per unit of data transported), a weighted maximum monthly data (e.g., such that data transported under the energy efficiency mode is weighted less than data transported under another mode), or the like. The UPF 330 of the core network 310 may support the incentivization of the alternative QoS profiles by recording an amount of data transported for QoS flows associated with the set of QoS profiles in the regular mode and an amount of data transported for QoS flows associated with the alternative QoS profiles during the energy efficiency mode. For example, the UPF 330 may record a data volume transported with the alternative QoS profile based on energy efficiency mode operation in a charging record or CDR associated with the UE 115-b.

The PCF 325 may include information associated with the set of QoS profiles associated with a regular operation, such as an operation different than the energy efficiency mode operation. Additionally, or alternatively, the PCF 325 may include information associated with the alternative QoS profiles associated with the energy efficiency mode operation. In some examples, the PCF 325 may include information associated with the alternative QoS profiles based on the UE 115-b being associated with an agreement to a policy associated with the energy efficiency mode. For example, a user associated with the UE 115-b may agree to the policy associated with the energy efficiency mode, where one or more parameters associated with performance of services may be reduced in accordance with the alternative Qos profiles.

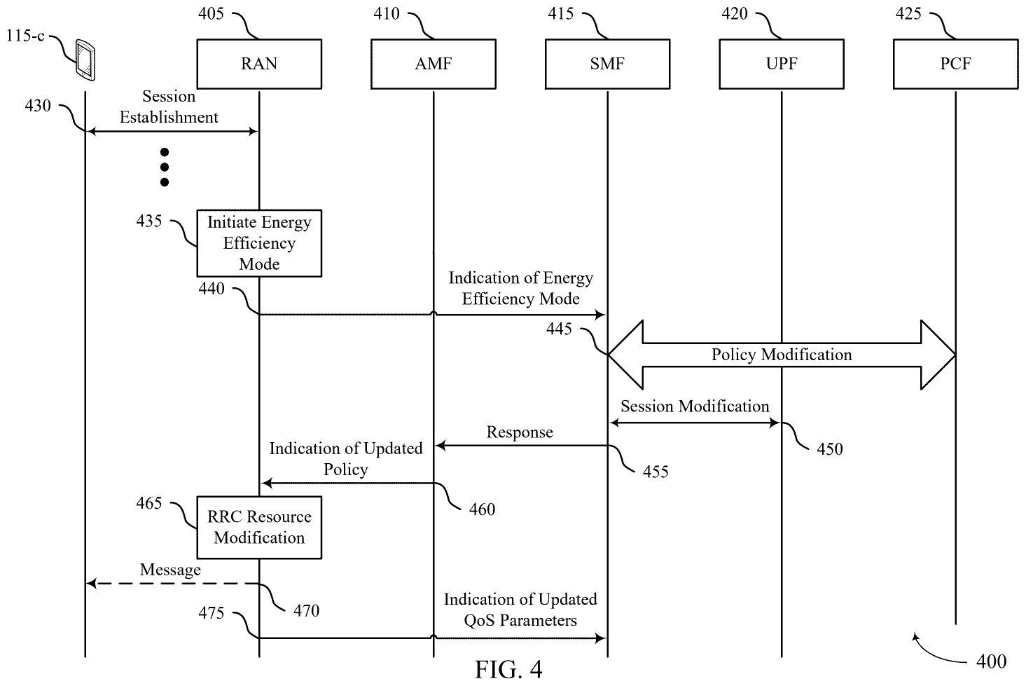

FIG. 4 shows an example of a process flow 400 that supports alternative QoS for energy efficiency mode operations in accordance with one or more aspects of the present disclosure. In some examples, the process flow 400 may implement or be implemented by aspects of the wireless communications system 100, the wireless communications system 300, or both. For example, the process flow 400 may include a UE 115-c, a RAN 405 (e.g., a RAN node, a network entity), an AMF 410, an SMF 415, a UPF 420, and a PCF 425, which may be examples of corresponding devices as illustrated by and described with reference to FIGS. 1, 2, and 3.

Alternative examples of the following may be implemented. Some operations are performed in a different order than described or are not performed at all. In some cases, operations may include additional features not mentioned below, or further operations may be added. Although the UE 115-c, the RAN 405, the AMF 410, the SMF 415, the UPF 420, and the PCF 425 are shown performing the operations of the process flow 400, some aspects of some operations may also be performed by one or more other wireless communication devices.

At 430, the RAN 405 and the UE 115-c may establish one or more PDU sessions via a session establishment procedure. At 435, the RAN 405 may initiate an energy efficiency mode. For example, the RAN 405 may have a PDU session with the UE 115-c, where the PDU session is associated with multiple QoS flows. Prior to initiating the energy efficiency mode at 435, the RAN 405 may perform a session establishment procedure with the UE 115-c to establish the PDU session. After establishing the PDU session, the RAN 405 may initiate the energy efficiency mode by identifying which (e.g., if any) of the multiple QoS flows of the PDU session are associated with QoS targets which may not be fulfilled (e.g., satisfied). In other words, the RAN 405 may estimate, for established QoS flows of the PDU session, whether current QoS parameters would be affected if the RAN 405 enters the energy efficiency mode. For example, the RAN 405 may identify which of the multiple QoS flows are associated with the QoS targets which may not be fulfilled based on network parameters. The network parameters may include a traffic load associated with one or more cells, a quantity of UEs (e.g., including the UE 115-c) associated with the RAN 405, a location of the UEs, a communication mode of the UEs, or the like.

Additionally, or alternatively, the RAN 405 may determine to enter the energy efficiency mode based on whether alternative QoS profiles associated with the energy efficiency mode were provided for the identified (e.g., affected) QoS flows. For example, prior to initiating the energy efficiency mode at 430, the RAN 405 may obtain (e.g., from the SMF 415 via the AMF 410) a message indicating QoS flows associated with the alternative QoS profiles. The alternative QoS profiles may be associated with a subset of QoS flows (e.g., one or more QoS flows) of the multiple QoS flows associated with the PDU session, and the alternative QoS profiles may be different from a set of QoS profiles of the PDU session. For example, the alternative QoS profiles may be associated with different parameters than parameters of the set of QoS profiles of the PDU session. The parameters may include a GBR, a MBR, a packet delay budget, a packet error rate, or any combination thereof. If a QoS target may not be satisfied for a QoS flow and if the QoS flow is indicated as being associated with the alternative QoS profiles for the energy efficiency mode (e.g., if the alternative QoS profiles are available for the affected QoS flows), the RAN 405 may determine to use an alternative QoS profile for the QoS flow. In other words, the RAN 405 may determine to enter the energy efficiency mode based on the network parameters (e.g., whether the QoS targets may be satisfied), where the energy efficiency mode is associated with the alternative QoS profiles.

In some examples, the alternative QoS profiles may be allowed for the PDU session based on an agreement associated with the UE 115-c. For example, the UE 115-c may agree or opt-in to the energy efficiency mode, where agreeing or opting-in may allow the RAN 405 to determine whether to initiate the energy efficiency mode at 430. Information associated with the agreement may be stored at and indicated by the PCF 425. That is, the PCF 425 may store information regarding QoS profiles that are allowed for a PDU session with the UE 115-c in accordance with the agreement associated with the UE 115-c. The PCF 425 may indicate, prior to initiation of the energy efficiency mode at 430, that the alternative QoS profiles are allowed for the PDU session with the UE 115-c to the RAN 405 based on the agreement.

In some examples, the alternative QoS profiles may be allowed for the PDU session based on agreements associated with multiple UEs connected to the RAN 405. That is, the RAN 405 may have established PDU sessions with (e.g., connections) to one or more UEs in addition to the UE 115-c. In such examples, the RAN 405 may be enabled to determine to enter the energy efficiency mode based on a threshold quantity of UEs connected to the RAN 405 agreeing to the energy efficiency mode.

After determining to enter the energy efficiency mode, the RAN 405 may initiate notification control based on energy efficiency mode operation. For example, at 440, the RAN 405 may output an indication of the energy efficiency mode to the SMF 415 via the AMF 410. In other words, the RAN 405 may output a message indicating that the RAN 405 is entering the energy efficiency mode and that the PDU session is modified in accordance with the alternative QoS profiles based on the energy efficiency mode. The message may further indicate that one or more QoS flows (e.g., the identified QoS flows) of the multiple QoS flows are modified in accordance with the alternative QoS profiles. That is, the message may indicate that the RAN 405 is entering the energy efficiency mode and indicate affected QoS flows to the SMF 415 via the AMF 410. Additionally, or alternatively, the RAN 405 may output a message indicating that the RAN 405 is entering the energy efficiency mode to the UE 115-c. For example, the RAN 405 may indicate that the alternative QoS is used in accordance with the energy efficiency mode.

In some examples, outputting the message to the SMF 415 via the AMF 410 may include outputting a first message to the SMF 415. For example, the first message may be an N2 message including a PDU session identifier, session management information, or both. The session management information may include QFIs associated with the one or more QoS flows (e.g., the identified QoS flows) and an indication that the QoS targets for the one or more QoS flows cannot be fulfilled. Additionally, or alternatively, the session management information may include a reference to an alternative QoS profile of the alternative QoS profiles matching one or more values of QoS parameters being currently fulfilled by the RAN 405 (e.g., prior to entering the energy efficiency mode). The RAN 405 may indicate, in the first message, that the alternative QoS profile is used based on the energy efficiency mode. For example, the RAN 405 may include multiple different alternative QoS profiles associated with different modes (e.g., emergency energy efficient modes) deployed at the RAN 405, and the RAN 405 may indicate which mode is deployed. In response to receiving the first message, the AMF 410 may output a second message to the SMF 415. For example, the first message (e.g., N_{SMF_PDUSession_UpdateSMContext}) may include an session management context identifier, the session management information, or both. The SMF 415 may obtain the second message from the SMF 415 based on the AMF 410 obtaining the first message from the RAN 405. That is, the SMF 415 may receive the indication of the energy efficiency mode and, in some examples, information associated with the energy efficiency mode (e.g., affected QoS flows) from the RAN 405 via the AMF 410.

At 445, the SMF 415 may perform policy modification with the PCF 425. For example, the SMF 415 may report that the RAN 405 has initiated the energy efficiency mode to the PCF 425 for each PCC rule for which notification control is set. In other words, the SMF 415 output a message indicating that the RAN 405 is entering the energy efficiency mode in accordance with one or more PCC rules, where the one or more PCC rules are associated with the energy efficiency mode. In some examples, the SMF 415 may output the message based on a notification control configured at the PCF 425.

At 450, the SMF 415 may perform session modification with the UPF 420. In other words, the SMF 415 may modify the PDU session in accordance with the alternative QoS profiles. For example, modifying the PDU session may include outputting a message indicating that the RAN 405 is entering the energy efficiency mode and identifying the QoS flows associated with the alternative QoS profiles in accordance with the energy efficiency mode. In other words, the SMF 415 may transmit a message (e.g., N4 session modification) to the UPF 420 initiating session modification, where the message may indicate which QoS flows are associated with the alternative QoS profiles based on the energy efficiency mode. The UPF 420 may update charging records and a CDR based on receiving the message. For example, the UPF 420 may update a CDR associated with the UE 115-c in accordance with a charging rate associated with the alternative QoS profiles.

At 455, the SMF 415 may transmit a response to the AMF 410. For example, the SMF 415 may output a response message (e.g., ResponseN_{SMF_PDUSession_UpdateSMContext}) including an indication of an updated PDU session in accordance with the modified PDU session and the alternative QoS profiles. That is, the SMF 415 may output the response message based on performing the policy modification at 445 in accordance with the alternative QoS profiles. The response message may include a PDU session identifier, session management information associated with the alternative QoS profiles, or both.

At 460, the AMF 410 may transmit an indication of an updated policy to the RAN 405. For example, in response to obtaining the response from the SMF 415 at 455 and based on the response indicating updated PCC rules, the AMF 410 may output a message (e.g., an N2 message) to update QoS parameters. That is, the AMF 410 may update one or more QoS parameters in accordance with the policy modification at 445, where the policy is modified based on the energy efficiency mode being used at the RAN 405.

At 465, the RAN 405 may perform RRC resource modification. For example, the RAN 405 may perform the RRC resource modification to update the one or more QoS parameters in accordance with the policy modification. That is, the RAN 405 may perform the RRC resource modification based on obtaining the indication of the updated policy at 460.

In some examples, at 470, the RAN 405 may optionally notify the UE 115-c that the RAN 405 is operating in the energy efficiency mode, and may further indicate that one or more alternative QoS profiles based on the energy efficiency mode operation are being used.

After performing the RRC resource modification at 465, the RAN 405 may transmit an indication of updated QoS parameters to the SMF 415 via the AMF 410 at 475. For example, the RAN 405 may indicate the updated QoS parameters after updating the QoS parameters via the RRC resource modification at 465.

In some examples, the RAN 405 may determine to exit the energy efficiency mode. For example, the RAN 405 may determine to exit the energy efficiency mode based on the network parameters including a traffic load associated with one or more cells, a quantity of UEs (e.g., including the UE 115-c) associated with the RAN 405, a location of the UEs, a communication mode of the UEs, or the like. The wireless devices of the process flow 400 may perform (e.g., repeat) one or more of the operations at 430 through 475 in accordance with the RAN 405 determining to exit the energy efficiency mode. As an example, the RAN 405 may output a message indicating that the RAN 405 is exiting the energy efficiency mode and that the PDU session is modified in accordance with the set of QoS profiles of the PDU session (e.g., different from the alternative QoS profiles) based on exiting the energy efficiency mode. In response to obtaining the message indicating that the RAN 405 is exiting the energy efficiency mode, the SMF 415 may modify the policy via the PCF 425, modify the session via the UPF 420, or both.

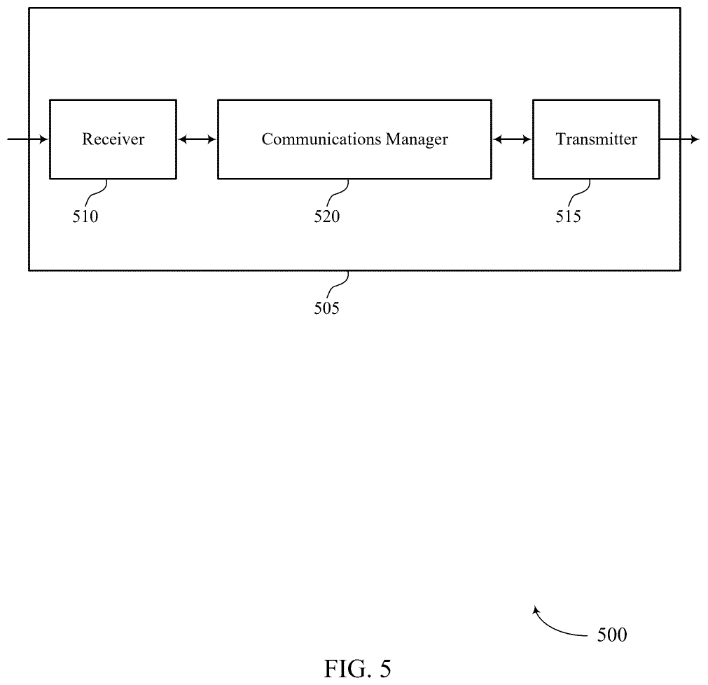

FIG. 5 shows a block diagram 500 of a device 505 that supports alternative QoS for energy efficiency mode operations in accordance with one or more aspects of the present disclosure. The device 505 may be an example of aspects of a RAN as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations or components thereof may be examples of means for performing various aspects of alternative QoS for energy efficiency mode operations as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for establishing a PDU session with a UE via a session establishment procedure. The communications manager 520 is capable of, configured to, or operable to support a means for determining to enter an energy efficiency mode based on one or more network parameters, where the energy efficiency mode is associated with one or more alternative QoS profiles that are different from a set of QoS profiles of the PDU session, and where the one or more alternative QoS profiles are allowed for the PDU session based on an agreement associated with the UE. The communications manager 520 is capable of, configured to, or operable to support a means for outputting a message indicating that the first network entity is entering the energy efficiency mode and that the PDU session is modified in accordance with the one or more alternative QoS profiles based on the energy efficiency mode.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing and reduced power consumption.

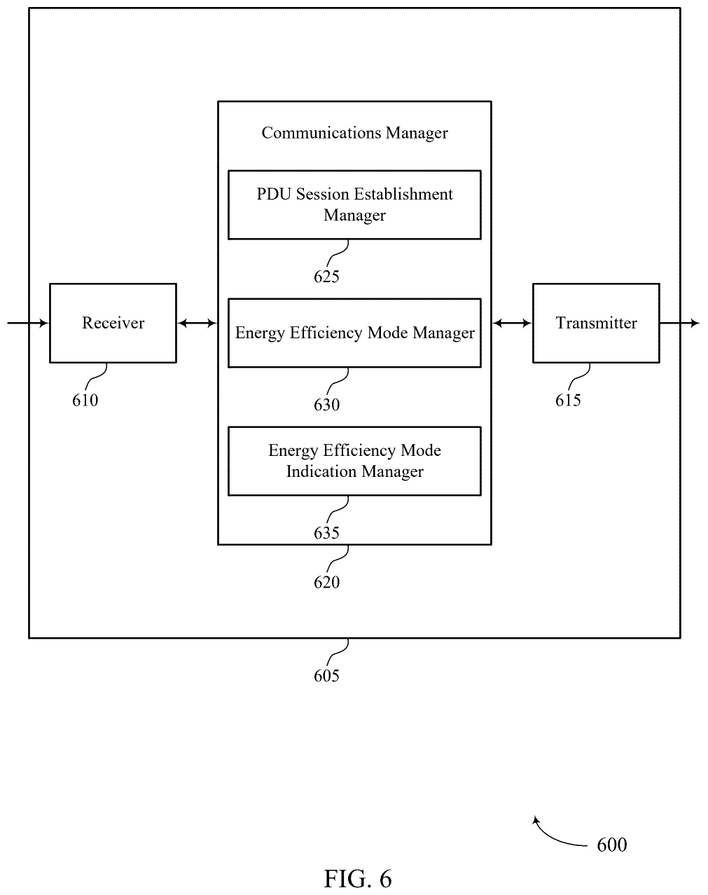

FIG. 6 shows a block diagram 600 of a device 605 that supports alternative QoS for energy efficiency mode operations in accordance with one or more aspects of the present disclosure. The device 605 may be an example of aspects of a device 505 or a RAN as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of alternative QoS for energy efficiency mode operations as described herein. For example, the communications manager 620 may include a PDU session establishment manager 625, an energy efficiency mode manager 630, an energy efficiency mode indication manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The PDU session establishment manager 625 is capable of, configured to, or operable to support a means for establishing a PDU session with a UE via a session establishment procedure. The energy efficiency mode manager 630 is capable of, configured to, or operable to support a means for determining to enter an energy efficiency mode based on one or more network parameters, where the energy efficiency mode is associated with one or more alternative QoS profiles that are different from a set of QoS profiles of the PDU session, and where the one or more alternative QoS profiles are allowed for the PDU session based on an agreement associated with the UE. The energy efficiency mode indication manager 635 is capable of, configured to, or operable to support a means for outputting a message indicating that the first network entity is entering the energy efficiency mode and that the PDU session is modified in accordance with the one or more alternative QoS profiles based on the energy efficiency mode.

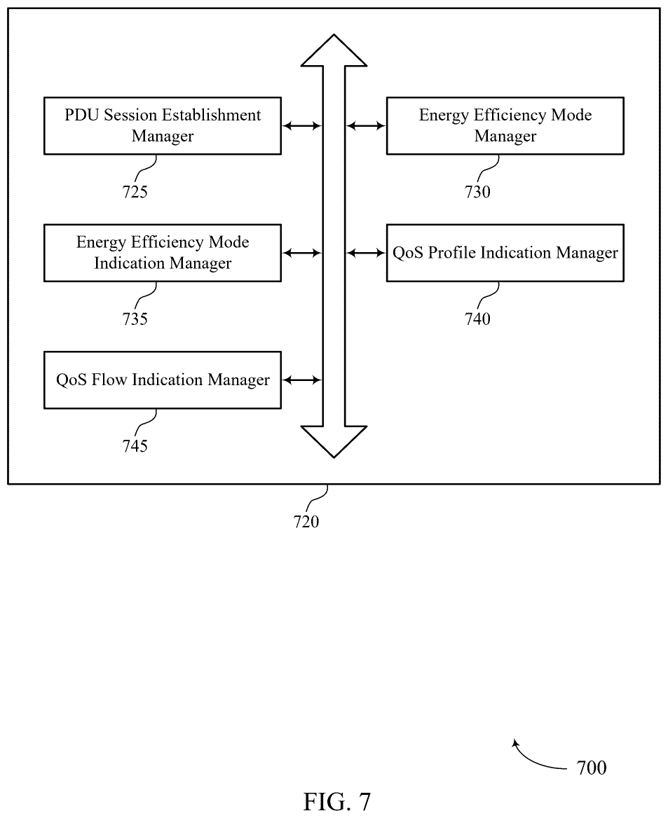

FIG. 7 shows a block diagram 700 of a communications manager 720 that supports alternative QoS for energy efficiency mode operations in accordance with one or more aspects of the present disclosure. The communications manager 720 may be an example of aspects of a communications manager 520, a communications manager 620, or both, as described herein. The communications manager 720, or various components thereof, may be an example of means for performing various aspects of alternative QoS for energy efficiency mode operations as described herein. For example, the communications manager 720 may include a PDU session establishment manager 725, an energy efficiency mode manager 730, an energy efficiency mode indication manager 735, a QoS profile indication manager 740, a QoS flow indication manager 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The PDU session establishment manager 725 is capable of, configured to, or operable to support a means for establishing a PDU session with a UE via a session establishment procedure. The energy efficiency mode manager 730 is capable of, configured to, or operable to support a means for determining to enter an energy efficiency mode based on one or more network parameters, where the energy efficiency mode is associated with one or more alternative QoS profiles that are different from a set of QoS profiles of the PDU session, and where the one or more alternative QoS profiles are allowed for the PDU session based on an agreement associated with the UE. The energy efficiency mode indication manager 735 is capable of, configured to, or operable to support a means for outputting a message indicating that the first network entity is entering the energy efficiency mode and that the PDU session is modified in accordance with the one or more alternative QoS profiles based on the energy efficiency mode.

In some examples, the energy efficiency mode manager 730 is capable of, configured to, or operable to support a means for determining to exit the energy efficiency mode based on the one or more network parameters. In some examples, the energy efficiency mode indication manager 735 is capable of, configured to, or operable to support a means for outputting a second message indicating that the first network entity is exiting the energy efficiency mode and that the PDU session is modified in accordance with the set of QoS profiles of the PDU session based on exiting the energy efficiency mode.

In some examples, the QoS profile indication manager 740 is capable of, configured to, or operable to support a means for obtaining a second message indicating the one or more alternative QoS profiles associated with the energy efficiency mode, where determining to enter the energy efficiency mode is based on receiving the second message.

In some examples, the QoS flow indication manager 745 is capable of, configured to, or operable to support a means for obtaining a second message indicating one or more QoS flows associated with the one or more alternative QoS profiles, where the PDU session is associated with the one or more QoS flows.

In some examples, to support outputting the message, the energy efficiency mode indication manager 735 is capable of, configured to, or operable to support a means for outputting, to the UE, the message indicating that the first network entity is entering the energy efficiency mode.

In some examples, to support outputting the message, the energy efficiency mode indication manager 735 is capable of, configured to, or operable to support a means for outputting, to a second network entity via a third network entity, the message indicating that the first network entity is entering the energy efficiency mode.

In some examples, the message indicates one or more QoS flows that are associated with the one or more alternative QoS profiles.

In some examples, the first network entity includes a RAN node, the second network entity includes a SMF, and the third network entity includes an AMF.

In some examples, the message further indicates a PDU session identifier, session management information, the one or more alternative QoS profiles, or any combination thereof. In some examples, the session management information includes one or more QFIs associated with the one or more alternative QoS profiles.

In some examples, the one or more network parameters include a traffic load associated with one or more cells, a quantity of one or more UEs associated with the first network entity, a location of the one or more UEs, a communication mode of the one or more UEs, or any combination thereof.

In some examples, the one or more alternative QoS profiles are associated with one or more first parameters. In some examples, the one or more first parameters are different than one or more second parameters associated with the set of Qos profiles. In some examples, the one or more first parameters and the one or more second parameters include a GBR, a MBR, a packet delay budget, a packet error rate, or any combination thereof.

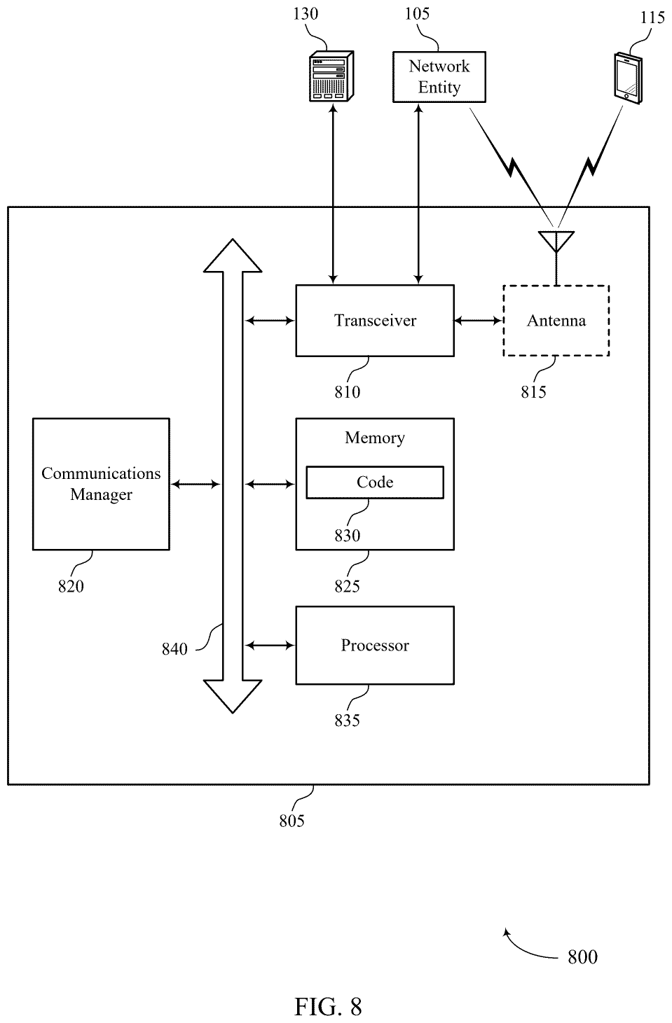

FIG. 8 shows a diagram of a system 800 including a device 805 that supports alternative QoS for energy efficiency mode operations in accordance with one or more aspects of the present disclosure. The device 805 may be an example of or include components of a device 505, a device 605, or a RAN as described herein. The device 805 may include components for bi-directional voice and data communications including components for transmitting and receiving communications, such as a communications manager 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting alternative QoS for energy efficiency mode operations). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825).

In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with one or more other network entities 105, and may include a controller or scheduler for controlling communications with UEs 115 (e.g., in cooperation with the one or more other network devices). In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for establishing a PDU session with a UE via a session establishment procedure. The communications manager 820 is capable of, configured to, or operable to support a means for determining to enter an energy efficiency mode based on one or more network parameters, where the energy efficiency mode is associated with one or more alternative QoS profiles that are different from a set of QoS profiles of the PDU session, and where the one or more alternative QoS profiles are allowed for the PDU session based on an agreement associated with the UE. The communications manager 820 is capable of, configured to, or operable to support a means for outputting a message indicating that the first network entity is entering the energy efficiency mode and that the PDU session is modified in accordance with the one or more alternative QoS profiles based on the energy efficiency mode.

By including or configuring the communications manager 820 in accordance with examples as described herein, the device 805 may support techniques for reduced power consumption and longer battery life.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of alternative QoS for energy efficiency mode operations as described herein, or the at least one processor 835 and the at least one memory 825 may be otherwise configured to, individually or collectively, perform or support such operations.

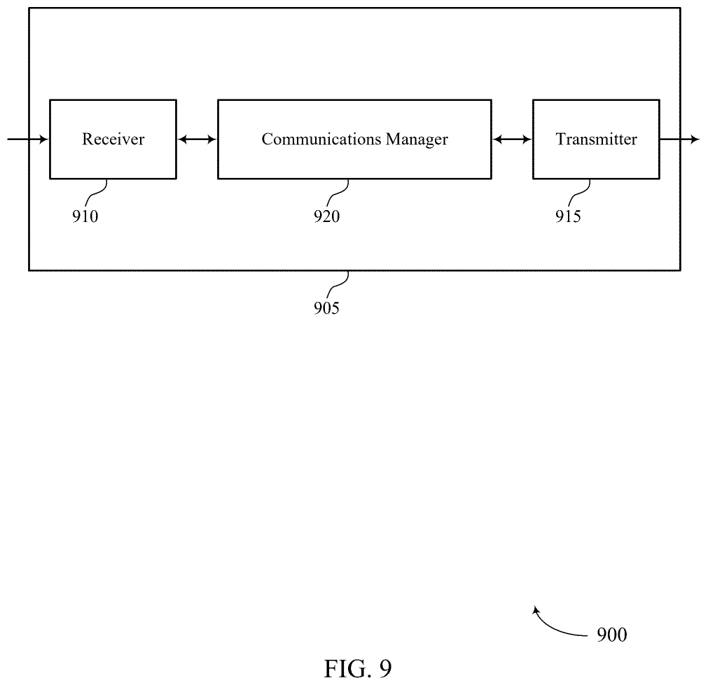

FIG. 9 shows a block diagram 900 of a device 905 that supports alternative QoS for energy efficiency mode operations in accordance with one or more aspects of the present disclosure. The device 905 may be an example of aspects of an SMF as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of alternative QoS for energy efficiency mode operations as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for obtaining a message indicating that a second network entity is entering an energy efficiency mode and further indicating that one or more QoS flows of a set of multiple QoS flows are modified in accordance with one or more alternative QoS profiles based on the energy efficiency mode, the one or more QoS flows associated with a PDU session between the first network entity and a UE, where the one or more alternative QoS profiles are different from a set of QoS profiles of the PDU session. The communications manager 920 is capable of, configured to, or operable to support a means for modifying the PDU session in accordance with the one or more alternative QoS profiles. The communications manager 920 is capable of, configured to, or operable to support a means for outputting a response message including an indication of an updated PDU session in accordance with the modified PDU session and the one or more alternative QoS profiles.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing and reduced power consumption.

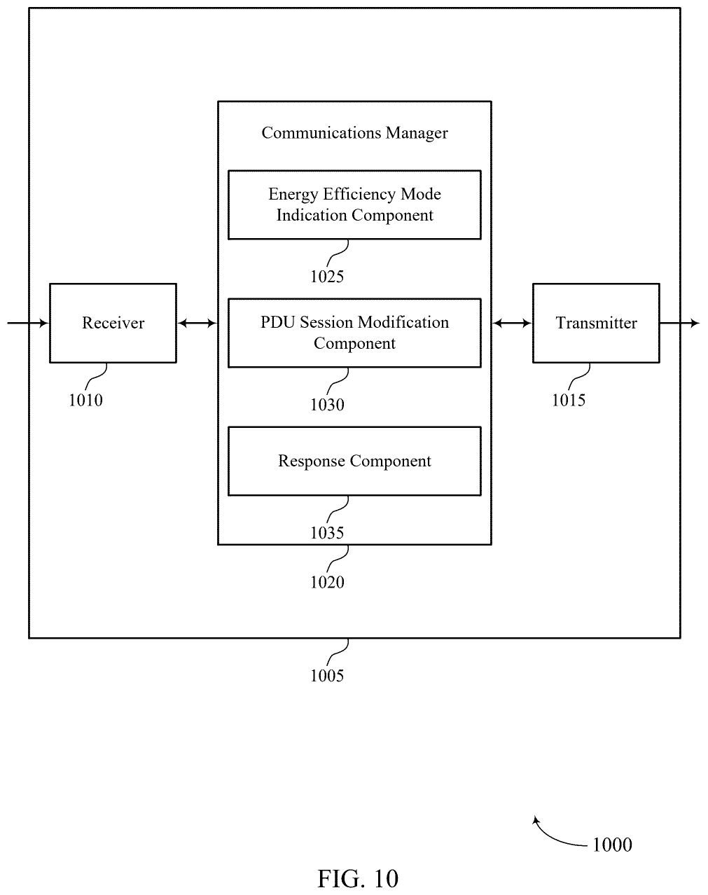

FIG. 10 shows a block diagram 1000 of a device 1005 that supports alternative QoS for energy efficiency mode operations in accordance with one or more aspects of the present disclosure. The device 1005 may be an example of aspects of a device 905 or an SMF as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of alternative QoS for energy efficiency mode operations as described herein. For example, the communications manager 1020 may include an energy efficiency mode indication component 1025, a PDU session modification component 1030, a response component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The energy efficiency mode indication component 1025 is capable of, configured to, or operable to support a means for obtaining a message indicating that a second network entity is entering an energy efficiency mode and further indicating that one or more QoS flows of a set of multiple QoS flows are modified in accordance with one or more alternative QoS profiles based on the energy efficiency mode, the one or more QoS flows associated with a PDU session between the first network entity and a UE, where the one or more alternative QoS profiles are different from a set of QoS profiles of the PDU session. The PDU session modification component 1030 is capable of, configured to, or operable to support a means for modifying the PDU session in accordance with the one or more alternative QoS profiles. The response component 1035 is capable of, configured to, or operable to support a means for outputting a response message including an indication of an updated PDU session in accordance with the modified PDU session and the one or more alternative QoS profiles.

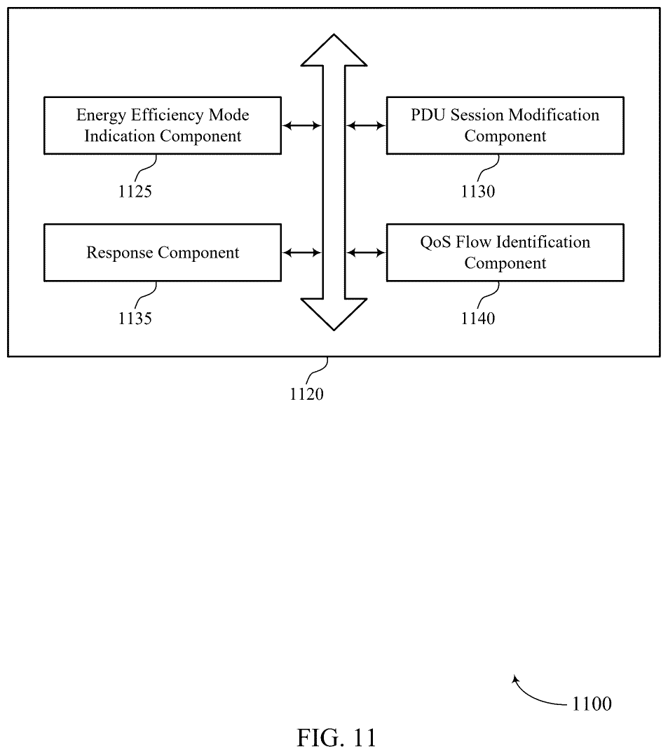

FIG. 11 shows a block diagram 1100 of a communications manager 1120 that supports alternative QoS for energy efficiency mode operations in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of alternative QoS for energy efficiency mode operations as described herein. For example, the communications manager 1120 may include an energy efficiency mode indication component 1125, a PDU session modification component 1130, a response component 1135, a QoS flow identification component 1140, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The energy efficiency mode indication component 1125 is capable of, configured to, or operable to support a means for obtaining a message indicating that a second network entity is entering an energy efficiency mode and further indicating that one or more QoS flows of a set of multiple QoS flows are modified in accordance with one or more alternative QoS profiles based on the energy efficiency mode, the one or more QoS flows associated with a PDU session between the first network entity and a UE, where the one or more alternative QOS profiles are different from a set of QOS profiles of the PDU session. The PDU session modification component 1130 is capable of, configured to, or operable to support a means for modifying the PDU session in accordance with the one or more alternative QoS profiles. The response component 1135 is capable of, configured to, or operable to support a means for outputting a response message including an indication of an updated PDU session in accordance with the modified PDU session and the one or more alternative QoS profiles.

In some examples, the energy efficiency mode indication component 1125 is capable of, configured to, or operable to support a means for outputting a second message indicating that the second network entity is entering the energy efficiency mode in accordance with one or more policy and charging control (PCC) rules, the one or more PCC rules associated with the energy efficiency mode.

In some examples, to support modifying the PDU session, the energy efficiency mode indication component 1125 is capable of, configured to, or operable to support a means for outputting a second message indicating that the second network entity is entering the energy efficiency mode and identifying one or more QoS flows associated with the one or more alternative QoS profiles in accordance with the energy efficiency mode.

In some examples, to support outputting the second message, the QoS flow identification component 1140 is capable of, configured to, or operable to support a means for outputting the second message identifying the one or more QoS flows associated with the one or more alternative QoS profiles, where a CDR associated with the UE is updated in accordance with a charging rate associated with the one or more alternative QoS profiles.

In some examples, the energy efficiency mode indication component 1125 is capable of, configured to, or operable to support a means for obtaining a second message indicating that the second network entity is exiting the energy efficiency mode and that the PDU session is modified in accordance with the set of QoS profiles of the PDU session based on exiting the energy efficiency mode.

In some examples, to support obtaining the message, the energy efficiency mode indication component 1125 is capable of, configured to, or operable to support a means for obtaining, from the second network entity via a third network entity, the message indicating that the second network entity is entering the energy efficiency mode.

In some examples, the first network entity includes an AMF, the second network entity includes a RAN node, and the third network entity includes a SMF.

In some examples, the message further indicates a PDU session identifier, session management information, the one or more alternative QoS profiles, or any combination thereof. In some examples, the session management information includes one or more QFIs associated with the one or more alternative QoS profiles.

In some examples, the one or more alternative QoS profiles are associated with one or more first parameters. In some examples, the one or more first parameters are different than one or more second parameters associated with the set of QoS profiles. In some examples, the one or more first parameters and the one or more second parameters include a GBR, a MBR, a packet delay budget, a packet error rate, or any combination thereof.

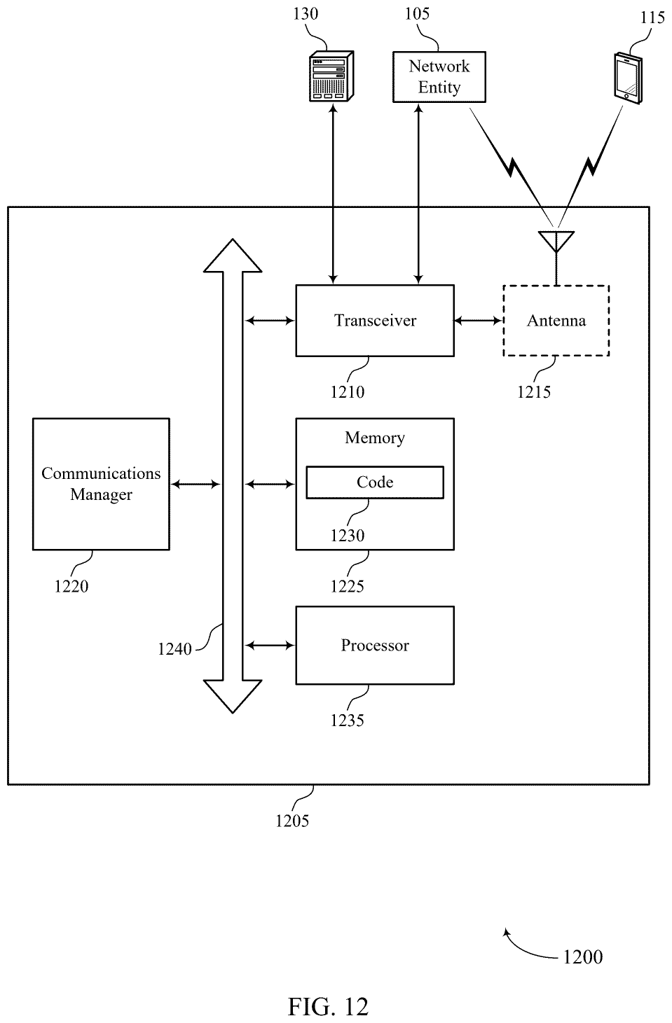

FIG. 12 shows a diagram of a system 1200 including a device 1205 that supports alternative QoS for energy efficiency mode operations in accordance with one or more aspects of the present disclosure. The device 1205 may be an example of or include components of a device 905, a device 1005, or an SMF as described herein. The device 1205 may include components for bi-directional voice and data communications including components for transmitting and receiving communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting alternative QoS for energy efficiency mode operations). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for obtaining a message indicating that a second network entity is entering an energy efficiency mode and further indicating that one or more QoS flows of a set of multiple QoS flows are modified in accordance with one or more alternative QoS profiles based on the energy efficiency mode, the one or more QoS flows associated with a PDU session between the first network entity and a UE, where the one or more alternative QoS profiles are different from a set of QoS profiles of the PDU session. The communications manager 1220 is capable of, configured to, or operable to support a means for modifying the PDU session in accordance with the one or more alternative QoS profiles. The communications manager 1220 is capable of, configured to, or operable to support a means for outputting a response message including an indication of an updated PDU session in accordance with the modified PDU session and the one or more alternative QoS profiles.

By including or configuring the communications manager 1220 in accordance with examples as described herein, the device 1205 may support techniques for reduced power consumption and longer battery life.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of alternative QoS for energy efficiency mode operations as described herein, or the at least one processor 1235 and the at least one memory 1225 may be otherwise configured to, individually or collectively, perform or support such operations.

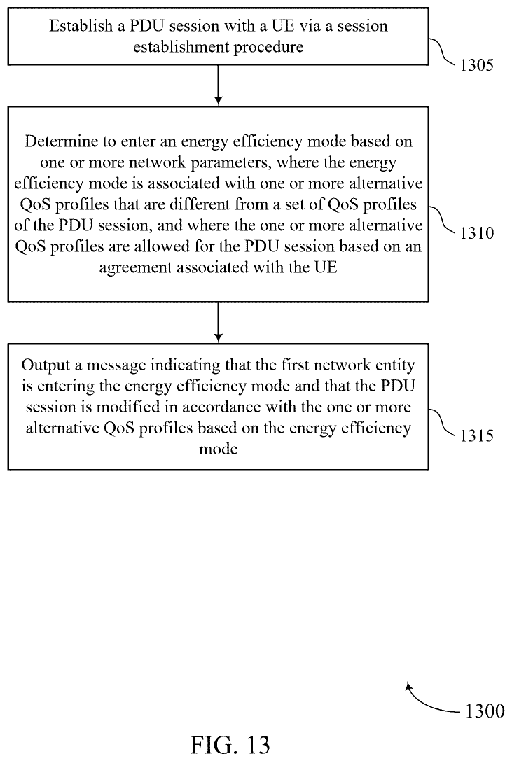

FIG. 13 shows a flowchart illustrating a method 1300 that supports alternative QoS for energy efficiency mode operations in accordance with one or more aspects of the present disclosure. The operations of the method 1300 may be implemented by a RAN or its components as described herein. For example, the operations of the method 1300 may be performed by a RAN as described with reference to FIGS. 1 through 8. In some examples, a RAN may execute a set of instructions to control the functional elements of the RAN to perform the described functions. Additionally, or alternatively, the RAN may perform aspects of the described functions using special-purpose hardware.

At 1305, the method may include establishing a PDU session with a UE via a session establishment procedure. The operations of 1305 may be performed in accordance with examples as disclosed herein. In some examples, aspects of the operations of 1305 may be performed by a PDU session establishment manager 725 as described with reference to FIG. 7.

At 1310, the method may include determining to enter an energy efficiency mode based on one or more network parameters, where the energy efficiency mode is associated with one or more alternative QoS profiles that are different from a set of QoS profiles of the PDU session, and where the one or more alternative QoS profiles are allowed for the PDU session based on an agreement associated with the UE. The operations of 1310 may be performed in accordance with examples as disclosed herein. In some examples, aspects of the operations of 1310 may be performed by an energy efficiency mode manager 730 as described with reference to FIG. 7.

At 1315, the method may include outputting a message indicating that the first network entity is entering the energy efficiency mode and that the PDU session is modified in accordance with the one or more alternative QoS profiles based on the energy efficiency mode. The operations of 1315 may be performed in accordance with examples as disclosed herein. In some examples, aspects of the operations of 1315 may be performed by an energy efficiency mode indication manager 735 as described with reference to FIG. 7.

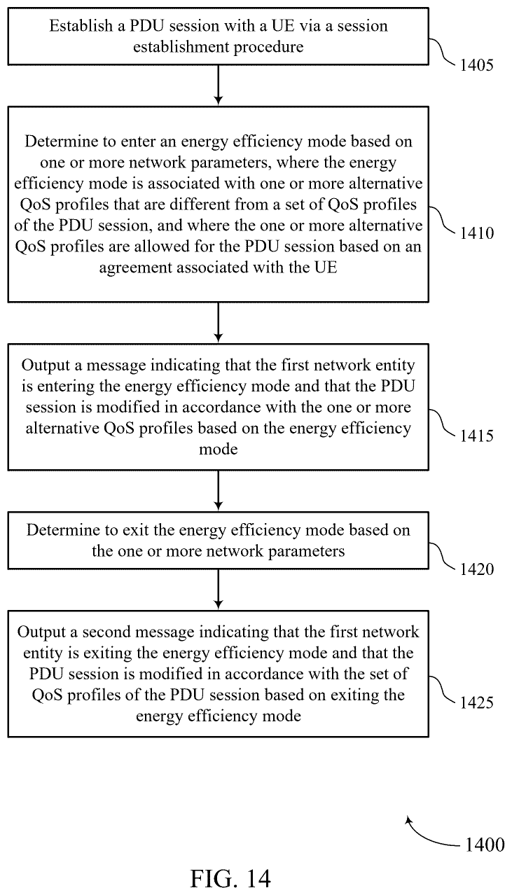

FIG. 14 shows a flowchart illustrating a method 1400 that supports alternative QoS for energy efficiency mode operations in accordance with one or more aspects of the present disclosure. The operations of the method 1400 may be implemented by a RAN or its components as described herein. For example, the operations of the method 1400 may be performed by a RAN as described with reference to FIGS. 1 through 8. In some examples, a RAN may execute a set of instructions to control the functional elements of the RAN to perform the described functions. Additionally, or alternatively, the RAN may perform aspects of the described functions using special-purpose hardware.

At 1405, the method may include establishing a PDU session with a UE via a session establishment procedure. The operations of 1405 may be performed in accordance with examples as disclosed herein. In some examples, aspects of the operations of 1405 may be performed by a PDU session establishment manager 725 as described with reference to FIG. 7.

At 1410, the method may include determining to enter an energy efficiency mode based on one or more network parameters, where the energy efficiency mode is associated with one or more alternative QoS profiles that are different from a set of QoS profiles of the PDU session, and where the one or more alternative QoS profiles are allowed for the PDU session based on an agreement associated with the UE. The operations of 1410 may be performed in accordance with examples as disclosed herein. In some examples, aspects of the operations of 1410 may be performed by an energy efficiency mode manager 730 as described with reference to FIG. 7.

At 1415, the method may include outputting a message indicating that the first network entity is entering the energy efficiency mode and that the PDU session is modified in accordance with the one or more alternative QoS profiles based on the energy efficiency mode. The operations of 1415 may be performed in accordance with examples as disclosed herein. In some examples, aspects of the operations of 1415 may be performed by an energy efficiency mode indication manager 735 as described with reference to FIG. 7.

At 1420, the method may include determining to exit the energy efficiency mode based on the one or more network parameters. The operations of 1420 may be performed in accordance with examples as disclosed herein. In some examples, aspects of the operations of 1420 may be performed by an energy efficiency mode manager 730 as described with reference to FIG. 7.

At 1425, the method may include outputting a second message indicating that the first network entity is exiting the energy efficiency mode and that the PDU session is modified in accordance with the set of QoS profiles of the PDU session based on exiting the energy efficiency mode. The operations of 1425 may be performed in accordance with examples as disclosed herein. In some examples, aspects of the operations of 1425 may be performed by an energy efficiency mode indication manager 735 as described with reference to FIG. 7.

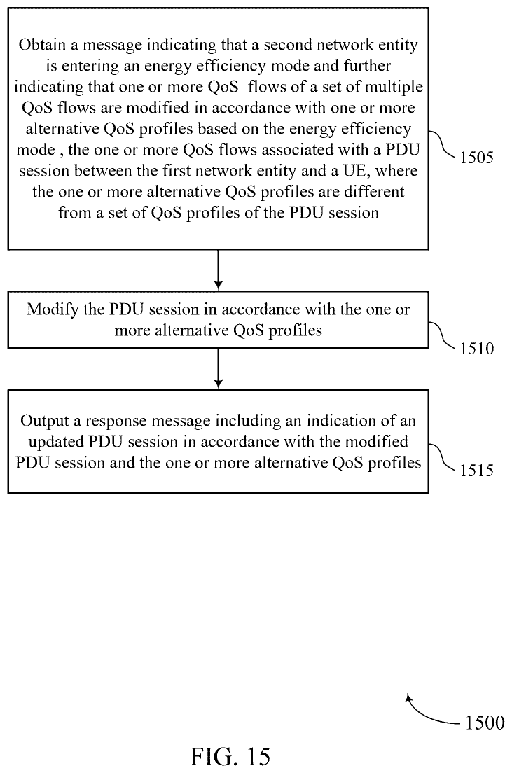

FIG. 15 shows a flowchart illustrating a method 1500 that supports alternative QoS for energy efficiency mode operations in accordance with one or more aspects of the present disclosure. The operations of the method 1500 may be implemented by an SMF or its components as described herein. For example, the operations of the method 1500 may be performed by an SMF as described with reference to FIGS. 1 through 4 and 9 through 12. In some examples, an SMF may execute a set of instructions to control the functional elements of the SMF to perform the described functions. Additionally, or alternatively, the SMF may perform aspects of the described functions using special-purpose hardware.

At 1505, the method may include obtaining a message indicating that a second network entity is entering an energy efficiency mode and further indicating that one or more QoS flows of a set of multiple QoS flows are modified in accordance with one or more alternative QoS profiles based on the energy efficiency mode, the one or more QoS flows associated with a PDU session between the first network entity and a UE, where the one or more alternative QoS profiles are different from a set of QoS profiles of the PDU session. The operations of 1505 may be performed in accordance with examples as disclosed herein. In some examples, aspects of the operations of 1505 may be performed by an energy efficiency mode indication component 1125 as described with reference to FIG. 11.

At 1510, the method may include modifying the PDU session in accordance with the one or more alternative QoS profiles. The operations of 1510 may be performed in accordance with examples as disclosed herein. In some examples, aspects of the operations of 1510 may be performed by a PDU session modification component 1130 as described with reference to FIG. 11.

At 1515, the method may include outputting a response message including an indication of an updated PDU session in accordance with the modified PDU session and the one or more alternative QoS profiles. The operations of 1515 may be performed in accordance with examples as disclosed herein. In some examples, aspects of the operations of 1515 may be performed by a response component 1135 as described with reference to FIG. 11.

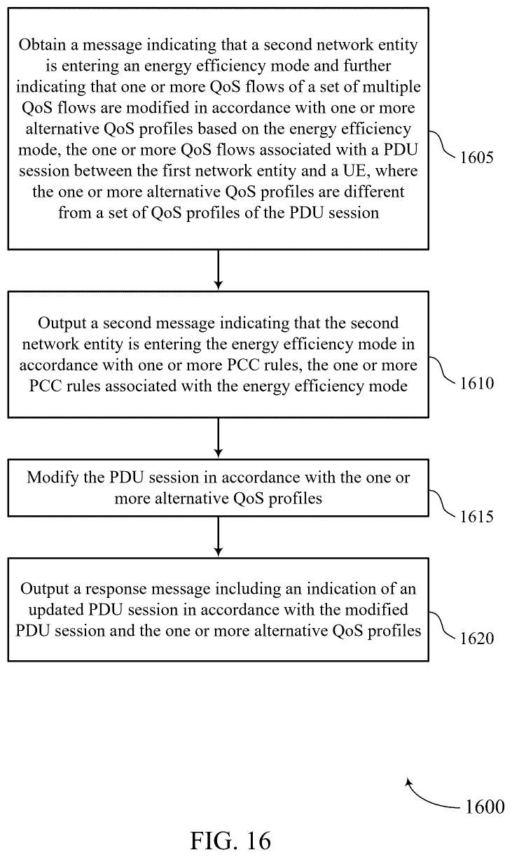

FIG. 16 shows a flowchart illustrating a method 1600 that supports alternative QoS for energy efficiency mode operations in accordance with one or more aspects of the present disclosure. The operations of the method 1600 may be implemented by an SMF or its components as described herein. For example, the operations of the method 1600 may be performed by an SMF as described with reference to FIGS. 1 through 4 and 9 through 12. In some examples, an SMF may execute a set of instructions to control the functional elements of the SMF to perform the described functions. Additionally, or alternatively, the SMF may perform aspects of the described functions using special-purpose hardware.

At 1605, the method may include obtaining a message indicating that a second network entity is entering an energy efficiency mode and further indicating that one or more QoS flows of a set of multiple QoS flows are modified in accordance with one or more alternative QoS profiles based on the energy efficiency mode, the one or more QoS flows associated with a PDU session between the first network entity and a UE, where the one or more alternative QoS profiles are different from a set of QoS profiles of the PDU session. The operations of 1605 may be performed in accordance with examples as disclosed herein. In some examples, aspects of the operations of 1605 may be performed by an energy efficiency mode indication component 1125 as described with reference to FIG. 11.

At 1610, the method may include outputting a second message indicating that the second network entity is entering the energy efficiency mode in accordance with one or more policy and charging control (PCC) rules, the one or more PCC rules associated with the energy efficiency mode. The operations of 1610 may be performed in accordance with examples as disclosed herein. In some examples, aspects of the operations of 1610 may be performed by an energy efficiency mode indication component 1125 as described with reference to FIG. 11.

At 1615, the method may include modifying the PDU session in accordance with the one or more alternative QoS profiles. The operations of 1615 may be performed in accordance with examples as disclosed herein. In some examples, aspects of the operations of 1615 may be performed by a PDU session modification component 1130 as described with reference to FIG. 11.

At 1620, the method may include outputting a response message including an indication of an updated PDU session in accordance with the modified PDU session and the one or more alternative QoS profiles. The operations of 1620 may be performed in accordance with examples as disclosed herein. In some examples, aspects of the operations of 1620 may be performed by a response component 1135 as described with reference to FIG. 11.

The following provides an overview of aspects of the present disclosure:

Aspect 1: A method for wireless communications by a first network entity, comprising: establishing a PDU session with a UE via a session establishment procedure; determining to enter an energy efficiency mode based at least in part on one or more network parameters, wherein the energy efficiency mode is associated with one or more alternative QoS profiles that are different from a set of QoS profiles of the PDU session, and wherein the one or more alternative QoS profiles are allowed for the PDU session based at least in part on an agreement associated with the UE; and outputting a message indicating that the first network entity is entering the energy efficiency mode and that the PDU session is modified in accordance with the one or more alternative QoS profiles based at least in part on the energy efficiency mode.

Aspect 2: The method of aspect 1, further comprising: determining to exit the energy efficiency mode based at least in part on the one or more network parameters; and outputting a second message indicating that the first network entity is exiting the energy efficiency mode and that the PDU session is modified in accordance with the set of QoS profiles of the PDU session based at least in part on exiting the energy efficiency mode.

Aspect 3: The method of any of aspects 1 through 2, further comprising: obtaining a second message indicating the one or more alternative QoS profiles associated with the energy efficiency mode, wherein determining to enter the energy efficiency mode is based at least in part on receiving the second message.

Aspect 4: The method of any of aspects 1 through 3, further comprising: obtaining a second message indicating one or more QoS flows associated with the one or more alternative QoS profiles, wherein the PDU session is associated with the one or more QoS flows.

Aspect 5: The method of any of aspects 1 through 4, wherein outputting the message comprises: outputting, to the UE, the message indicating that the first network entity is entering the energy efficiency mode.

Aspect 6: The method of any of aspects 1 through 5, wherein outputting the message comprises: outputting, to a second network entity via a third network entity, the message indicating that the first network entity is entering the energy efficiency mode.

Aspect 7: The method of aspect 6, wherein the message indicates one or more QoS flows that are associated with the one or more alternative QoS profiles.

Aspect 8: The method of any of aspects 6 through 7, wherein the first network entity comprises a RAN node, the second network entity comprises a SMF, and the third network entity comprises an AMF

Aspect 9: The method of any of aspects 1 through 8, wherein the message further indicates a PDU session identifier, session management information, the one or more alternative QoS profiles, or any combination thereof, and the session management information comprises one or more QFIs associated with the one or more alternative QoS profiles.

Aspect 10: The method of any of aspects 1 through 9, wherein the one or more network parameters comprise a traffic load associated with one or more cells, a quantity of one or more UEs associated with the first network entity, a location of the one or more UEs, a communication mode of the one or more UEs, or any combination thereof.

Aspect 11: The method of any of aspects 1 through 10, wherein the one or more alternative QoS profiles are associated with one or more first parameters, the one or more first parameters are different than one or more second parameters associated with the set of QoS profiles, and the one or more first parameters and the one or more second parameters comprise a GBR, a MBR, a packet delay budget, a packet error rate, or any combination thereof.

Aspect 12: A method for wireless communications by a first network entity, comprising: obtaining a message indicating that a second network entity is entering an energy efficiency mode and further indicating that one or more QoS flows of a plurality of QoS flows are modified in accordance with one or more alternative QoS profiles based at least in part on the energy efficiency mode, the one or more QoS flows associated with a PDU session between the first network entity and a UE, wherein the one or more alternative QoS profiles are different from a set of QOS profiles of the PDU session; modifying the PDU session in accordance with the one or more alternative QoS profiles; and outputting a response message comprising an indication of an updated PDU session in accordance with the modified PDU session and the one or more alternative QoS profiles.

Aspect 13: The method of aspect 12, further comprising: outputting a second message indicating that the second network entity is entering the energy efficiency mode in accordance with one or more PCC rules, the one or more PCC rules associated with the energy efficiency mode.

Aspect 14: The method of any of aspects 12 through 13, wherein modifying the PDU session further comprises: outputting a second message indicating that the second network entity is entering the energy efficiency mode and identifying one or more QoS flows associated with the one or more alternative QoS profiles in accordance with the energy efficiency mode.

Aspect 15: The method of aspect 14, wherein outputting the second message further comprises: outputting the second message identifying the one or more Qos flows associated with the one or more alternative QoS profiles, wherein a usage CDR associated with the UE is updated in accordance with a charging rate associated with the one or more alternative QoS profiles.

Aspect 16: The method of any of aspects 12 through 15, further comprising: obtaining a second message indicating that the second network entity is exiting the energy efficiency mode and that the PDU session is modified in accordance with the set of QoS profiles of the PDU session based at least in part on exiting the energy efficiency mode.

Aspect 17: The method of any of aspects 12 through 16, wherein obtaining the message comprises: obtaining, from the second network entity via a third network entity, the message indicating that the second network entity is entering the energy efficiency mode.

Aspect 18: The method of aspect 17, wherein the first network entity comprises an AMF, the second network entity comprises a RAN node, and the third network entity comprises a SMF.

Aspect 19: The method of any of aspects 12 through 18, wherein the message further indicates a PDU session identifier, session management information, the one or more alternative QoS profiles, or any combination thereof, and the session management information comprises one or more QFIs associated with the one or more alternative QoS profiles.

Aspect 20: The method of any of aspects 12 through 19, wherein the one or more alternative QoS profiles are associated with one or more first parameters, the one or more first parameters are different than one or more second parameters associated with the set of QoS profiles, and the one or more first parameters and the one or more second parameters comprise a GBR, a MBR, a packet delay budget, a packet error rate, or any combination thereof.

Aspect 21: A first network entity for wireless communications, comprising one or more memories storing processor-executable code, and one or more processors coupled with the one or more memories and individually or collectively operable to execute the code to cause the first network entity to perform a method of any of aspects 1 through 11.

Aspect 22: A first network entity for wireless communications, comprising at least one means for performing a method of any of aspects 1 through 11.

Aspect 23: A non-transitory computer-readable medium storing code for wireless communications, the code comprising instructions executable by one or more processors to perform a method of any of aspects 1 through 11.

Aspect 24: A first network entity for wireless communications, comprising one or more memories storing processor-executable code, and one or more processors coupled with the one or more memories and individually or collectively operable to execute the code to cause the first network entity to perform a method of any of aspects 12 through 20.

Aspect 25: A first network entity for wireless communications, comprising at least one means for performing a method of any of aspects 12 through 20.

Aspect 26: A non-transitory computer-readable medium storing code for wireless communications, the code comprising instructions executable by one or more processors to perform a method of any of aspects 12 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity, comprising:
one or more memories storing processor-executable code; and
one or more processors coupled with the one or more memories and individually or collectively operable to execute the code to cause the first network entity to:
establish a packet data unit (PDU) session with a user equipment (UE) via a session establishment procedure;
determine to enter an energy efficiency mode based at least in part on one or more network parameters, wherein the energy efficiency mode is associated with one or more alternative quality of service (QOS) profiles that are different from a set of QoS profiles of the PDU session, and wherein the one or more alternative QoS profiles are allowed for the PDU session based at least in part on an agreement associated with the UE; and
output a message indicating that the first network entity is entering the energy efficiency mode and that the PDU session is modified in accordance with the one or more alternative QoS profiles based at least in part on the energy efficiency mode.

2. The first network entity of claim 1, wherein the one or more processors are individually or collectively further operable to execute the code to cause the first network entity to:
determine to exit the energy efficiency mode based at least in part on the one or more network parameters; and
output a second message indicating that the first network entity is exiting the energy efficiency mode and that the PDU session is modified in accordance with the set of QoS profiles of the PDU session based at least in part on exiting the energy efficiency mode.

3. The first network entity of claim 1, wherein the one or more processors are individually or collectively further operable to execute the code to cause the first network entity to:
obtain a second message indicating the one or more alternative QoS profiles associated with the energy efficiency mode, wherein determining to enter the energy efficiency mode is based at least in part on receiving the second message.

4. The first network entity of claim 1, wherein the one or more processors are individually or collectively further operable to execute the code to cause the first network entity to:
obtain a second message indicating one or more QoS flows associated with the one or more alternative QoS profiles, wherein the PDU session is associated with the one or more QoS flows.

5. The first network entity of claim 1, wherein, to output the message, the one or more processors are individually or collectively operable to execute the code to cause the first network entity to:
output, to the UE, the message indicating that the first network entity is entering the energy efficiency mode.

6. The first network entity of claim 1, wherein, to output the message, the one or more processors are individually or collectively operable to execute the code to cause the first network entity to:
output, to a second network entity via a third network entity, the message indicating that the first network entity is entering the energy efficiency mode.

7. The first network entity of claim 6, wherein the message indicates one or more QoS flows that are associated with the one or more alternative QoS profiles.

8. The first network entity of claim 6, wherein the first network entity comprises a radio access network (RAN) node, the second network entity comprises a session management function (SMF), and the third network entity comprises an access and mobility management function (AMF).

9. The first network entity of claim 1, wherein:
the message further indicates a PDU session identifier, session management information, the one or more alternative QoS profiles, or any combination thereof, and
the session management information comprises one or more QoS flow identifiers (QFIs) associated with the one or more alternative QoS profiles.

10. The first network entity of claim 1, wherein the one or more network parameters comprise a traffic load associated with one or more cells, a quantity of one or more UEs associated with the first network entity, a location of the one or more UEs, a communication mode of the one or more UEs, or any combination thereof.

11. The first network entity of claim 1, wherein:
the one or more alternative QoS profiles are associated with one or more first parameters,
the one or more first parameters are different than one or more second parameters associated with the set of QoS profiles, and
the one or more first parameters and the one or more second parameters comprise a guaranteed bit rate (GBR), a maximum bit rate (MBR), a packet delay budget, a packet error rate, or any combination thereof.

12. A first network entity, comprising:
one or more memories storing processor-executable code; and
one or more processors coupled with the one or more memories and individually or collectively operable to execute the code to cause the first network entity to:
obtain a message indicating that a second network entity is entering an energy efficiency mode and further indicating that one or more Quality of Service (QOS) flows of a plurality of QoS flows are modified in accordance with one or more alternative QoS profiles based at least in part on the energy efficiency mode, the one or more QoS flows associated with a packet data unit (PDU) session between the first network entity and a user equipment (UE), wherein the one or more alternative QoS profiles are different from a set of QoS profiles of the PDU session;
modify the PDU session in accordance with the one or more alternative QoS profiles; and
output a response message comprising an indication of an updated PDU session in accordance with the modified PDU session and the one or more alternative QoS profiles.

13. The first network entity of claim 12, wherein the one or more processors are individually or collectively further operable to execute the code to cause the first network entity to:
output a second message indicating that the second network entity is entering the energy efficiency mode in accordance with one or more policy and charging control (PCC) rules, the one or more PCC rules associated with the energy efficiency mode.

14. The first network entity of claim 12, wherein, to modify the PDU session, the one or more processors are individually or collectively further operable to execute the code to cause the first network entity to:
output a second message indicating that the second network entity is entering the energy efficiency mode and identifying one or more QoS flows associated with the one or more alternative QoS profiles in accordance with the energy efficiency mode.

15. The first network entity of claim 14, wherein, to output the second message, the one or more processors are individually or collectively further operable to execute the code to cause the first network entity to:
output the second message identifying the one or more QoS flows associated with the one or more alternative QoS profiles, wherein a usage charging data record (CDR) associated with the UE is updated in accordance with a charging rate associated with the one or more alternative QoS profiles.

16. The first network entity of claim 12, wherein the one or more processors are individually or collectively further operable to execute the code to cause the first network entity to:
obtain a second message indicating that the second network entity is exiting the energy efficiency mode and that the PDU session is modified in accordance with the set of QoS profiles of the PDU session based at least in part on exiting the energy efficiency mode.

17. The first network entity of claim 12, wherein, to obtain the message, the one or more processors are individually or collectively operable to execute the code to cause the first network entity to:
obtain, from the second network entity via a third network entity, the message indicating that the second network entity is entering the energy efficiency mode.

18. The first network entity of claim 17, wherein the first network entity comprises an access and mobility management function (AMF), the second network entity comprises a radio access network (RAN) node, and the third network entity comprises a session management function (SMF).

19. A method for wireless communications by a first network entity, comprising:
establishing a packet data unit (PDU) session with a user equipment (UE) via a session establishment procedure;
determining to enter an energy efficiency mode based at least in part on one or more network parameters, wherein the energy efficiency mode is associated with one or more alternative quality of service (QOS) profiles that are different from a set of QoS profiles of the PDU session, and wherein the one or more alternative QoS profiles are allowed for the PDU session based at least in part on an agreement associated with the UE; and
outputting a message indicating that the first network entity is entering the energy efficiency mode and that the PDU session is modified in accordance with the one or more alternative QoS profiles based at least in part on the energy efficiency mode.

20. The method of claim 19, further comprising:
determining to exit the energy efficiency mode based at least in part on the one or more network parameters; and
outputting a second message indicating that the first network entity is exiting the energy efficiency mode and that the PDU session is modified in accordance with the set of QoS profiles of the PDU session based at least in part on exiting the energy efficiency mode.
